(19) United States
(12) Patent Application Publication
(10) Pub. No.: US 2010/0138284 A1
(43) Pub. Date: Jun. 3, 2010

(54) METHOD FOR MANAGING CUSTOMER-ORIENTED SERVICE LEVEL AGREEMENT METRICS AND PROFILE QUALITY AND SERVICE LEVEL AGREEMENT SYSTEM THEREOF

(76) Inventors: Mi Kyong HAN, Daejeon (KR); Boo-Sun JEON, Daejeon (KR); Ho Young SONG, Daejeon (KR); Byung Sun LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/559,614

(22) Filed: Sep. 15, 2009

(30) Foreign Application Priority Data
Dec. 2, 2008 (KR) 10-2008-0121429
Apr. 8, 2009 (KR) 10-2009-0030437

(51) Int. Cl. G06Q 10/00

(52) U.S. Cl. 705/11; 705/400; 705/7

(57) ABSTRACT

Provided are a method for managing a customer-oriented service level agreement metrics and profile quality, and a service level agreement system thereof. The system includes an interworking device, a customer-oriented SLA metrics managing device, an SLA quality managing device, and a providing device. The interworking device collects quality information, which includes information on SLA agreement metrics of a customer, profile quality, fault quality, and network performance quality, and subscriber information for each customer, and the customer-oriented SLA metrics managing device generates the customer-oriented profile quality monitoring information corresponding to a customer based on the received SLA metrics and metrics value for each customer to manage quality.

### CROSS-REFERENCE TO RELATED APPLICATION

This application claims priority to and the benefit of Korean Patent Application No. 10-2008-0121429 and 10-2009-0030437 filed in the Korean Intellectual Property Office on Dec. 2, 2008 and Apr. 8, 2009, the entire contents of which are incorporated herein by reference.

### BACKGROUND OF THE INVENTION

(a) Field of the Invention

The present invention relates to a method for managing a Customer-Oriented Service Level Agreement (hereinafter referred to as “SLA”) metrics and profile quality, and a system for managing customer-oriented service level agreement thereof.

(b) Description of the Related Art

A system for managing an SLA has been designed and developed to manage quality of a service or goods provided to customers, which are subscribed to the same service or the same goods of a service, based on the same quality metrics and the same quality metrics threshold value. The SLA managing system manages the metrics or the metrics threshold value at the minimum quality level that can be guaranteed by a communication operator.

Therefore, someone among customers using the same service or the same goods may complain about quality that is being managed, and may be not satisfied with the quality management for the service or the goods.

Since the customers need different metricses and metrics threshold values for the quality management and have different quality dependence, the compensation level due to the quality violation should be stipulated and be managed with each customer in order to meet characteristics of each customer.

Further, the communication operators need a quality managing system for providing quality that can satisfy the customers under an environment in which a market competition scheme for an Internet Protocol Television (IPTV) service or a convergence and complex service is changing from price based competition to high-quality service based competition that is based on quality of experience of customer.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for managing a customer-oriented service level agreement metrics and profile quality, and a service level agreement system thereof.

In order to achieve the above object, an exemplary embodiment of the present invention provides a system for managing a customer-oriented service level agreement that manages a customer-oriented service level agreement metrics and profile quality, including:

an interworking device that collects quality information including an SLA agreement metrics of a customer, metrics value, compensation level, profile quality information, fault quality information, network performance quality information and subscriber information for each customer; a customer-oriented SLA metrics managing device that generates customer-oriented profile quality monitoring information corresponding to the customer based on the received SLA agreement metrics and metrics value for each customer and manages the quality; an SLA quality managing device that monitors whether there is quality violation possibility for the generated customer-oriented profile quality monitoring information and determines the quality violation or not based on the SLA metrics and metrics value for each customer to perform the compensation processing corresponding to the quality violation according to the determination result; and a providing device that provides statistical information on the quality level and the quality violation corresponding to the customer-oriented profile quality monitoring information and provides the statistical information to the customer.

Another embodiment of the present invention provides a method for managing a customer-oriented service level agreement metrics and profile quality, including:

collecting quality information, which includes an SLA agreement metrics of a customer, metrics value, compensation level, profile quality information, fault quality information, network performance quality information and subscriber information for each customer; managing quality by generating customer-oriented profile quality monitoring information corresponding to the customer based on the received SLA agreement metrics and metrics value for each customer; monitoring quality violation possibility or not for the generated customer-oriented profile quality monitoring information; and generating statistical information on quality violation and a quality level corresponding to customer-oriented profile quality monitoring information and providing the statistical information to the customer.

### BRIEF DESCRIPTION OF THE DRAWINGS

FIG. 1 is a block diagram showing a structure of a system for managing a service level agreement according to an exemplary embodiment of the present invention;

FIG. 2 is a diagram showing interface information to allow a system for managing a service level agreement according to an exemplary embodiment of the present invention to receive information from an opening management system;

FIG. 3 is a diagram showing a customer-oriented metrics information management table according to an exemplary embodiment of the present invention;

FIG. 4 is a flowchart showing a method for managing a customer-oriented service level agreement metrics and profile quality according to an exemplary embodiment of the present invention;

FIG. 5 is a flowchart showing a method for managing an SLA corresponding to a subscription order type of subscription types according to an exemplary embodiment of the present invention;

FIG. 6 is a flowchart showing a method for managing an SLA corresponding to a cancellation order type of subscription types according to an exemplary embodiment of the present invention;

FIG. 7 is a flowchart showing a method for managing an SLA corresponding to a completion order type of subscription types according to an exemplary embodiment of the present invention; and

FIG. 8 is a flowchart showing a method for processing a management function of a second table and a third table shown in FIG. 3.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a customer-oriented service level agreement (hereinafter referred to as “SLA”) metrics management, a method for managing profile quality, and a system for managing a customer-oriented service level agreement thereof according to an exemplary embodiment of the present invention will be described with reference to the accompanying drawings.

A customer-oriented service level agreement (SLA) according to an exemplary embodiment of the present invention means an agreement that is previously concluded with another party with relation to a quality guarantee level that is expected by any one of a communication service provider and a subscriber (customer). In other words, the SLA is a technology that monitors and manages whether the agreement quality with the subscriber is violated or not.

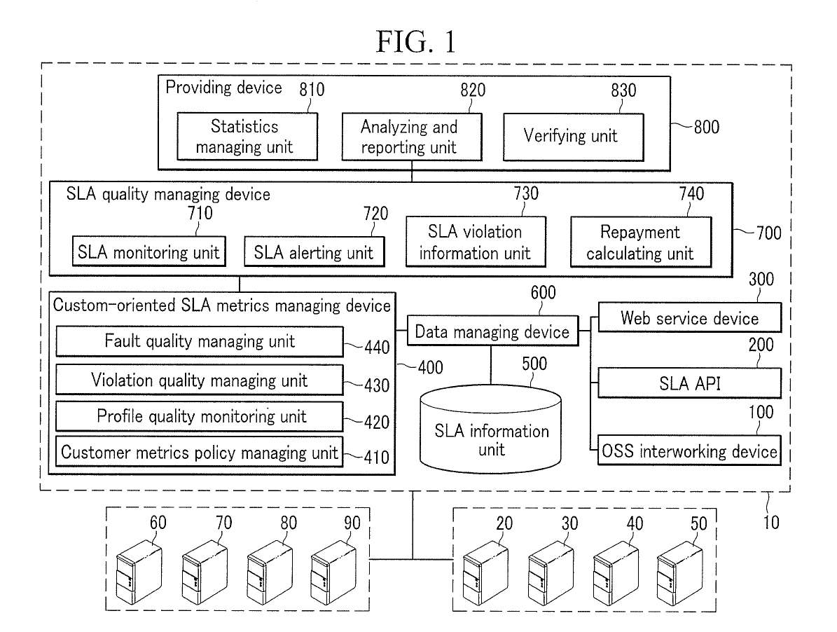

FIG. 1 is a block diagram showing a structure of a service level agreement system for managing a customer-oriented SLA according to an exemplary embodiment of the present invention.

Referring to FIG. 1, the service level agreement system 10 for managing a customer-oriented SLA (hereinafter referred to as “system for managing SLA”) includes open source software (hereinafter referred to as “OSS”) interworking 100, an SLA application programming interface device (hereinafter referred to as “SLA API”) 200, a web service device 300, a customer managing device 400, an SLA information unit 500, a data managing device 600, an SLA quality managing device 700, and a providing device 800.

Further, the system 10 for managing an SLA is operated by being linked with an opening management system 20 that exists outside the system, a fault management system 30, a subscriber information management server 40, a field work management system 50, a network management system (hereinafter referred to as “xNMS”) 60, a voice of customer (VOC) system 70, a customer verification management system 80, and a rate management system 90.

The OSS interworking device 100 collects quality information, that is external quality information which includes an SLA agreement metrics of a customer, metrics value, compensation level, profile quality information, fault quality inforamtion, network performance quality information, and subscriber information, etc., for each customer.

In detail, the OSS interworking device 100 is operated to link with the opening management system 20, the fault management system 30, and the xNMS 60 in order to collect the external quality information. Further, the OSS interworking device 100 is linked with a facility other than the subscriber information through the profile quality information among the collected external quality information or the subscriber information management server 40 for collecting the subscriber detailed information, and is operated to link with the field work management system 50 for transmitting and receiving additional information associated with the profile quality information.

The OSS interworking device 100 performs the work of verifying the corresponding information through the link with the VOC system 70 and the customer verification management system 80 in order to perform the verification work on the quality violation information to be managed, and performs the compensation function through the link with the rate management system 90 by the stipulated compensation scheme for the violated quality information through the verification work.

The SLA API 200 and the web service device 300 receive the quality information that is managed within the system for managing an SLA through the external system or the user interface.

The customer-oriented SLA metrics managing device 400 includes a customer metrics policy managing unit 410, a profile quality monitoring unit 420, a violation quality managing unit 430, and a fault quality managing unit 440.

The customer metrics policy managing unit 410 collects the customer-oriented SLA agreement metrics and metrics value information and the compensation level information for each metrics from the opening management system 20, and stores and manages it in the SLA information unit 500.

The profile quality monitoring unit 420 generates the customer-oriented profile quality monitoring information on the profile quality based on the customer-oriented SLA agreement metrics and metrics value.

The violation quality managing unit 430 manages the violation quality of the generated customer-oriented profile quality monitoring information.

The fault quality managing unit 440 manages the customer-oriented fault quality management information.

The SLA information unit 500 stores the customer-oriented SLA agreement metrics and metrics value information and the compensation level information for each metrics.

The data managing device 600 performs management, such as inquiry, insertion, deletion, and change, for all the data of the SLA information unit 500.

The SLA quality managing device 700 includes an SLA monitoring unit 710, an SLA alerting unit 720, an SLA violation information unit 730, and a repayment calculating unit 740.

The SLA monitoring unit 710 periodically monitors quality violation possibility or not through the quality monitoring information generated in the profile quality monitoring unit 420, the violation quality managing unit 430, and the fault quality managing unit 440.

The SLA alerting unit 720 generates alerting information, and informs an operator thereof when there is the violation possibility according to results monitored in the SLA monitoring unit 710.

The SLA violation information unit 730 generates the violation information and transmits the generated violation information to a verifying unit 830, when the violation on the quality managed in the profile quality monitoring unit 420, the violation quality managing unit 430, and the fault quality managing unit 440 occurs.

The repayment calculating unit 740 calculates repayment based on the customer-oriented SLA agreement metrics and metrics value and the compensation level for each metrics. Further, the repayment calculating unit 740 is linked with the rate management system 90, making it possible to perform the compensation through the calculated repayment.

The providing device 800 includes a statistics managing unit 810, an analyzing and reporting unit 820, and the verifying unit 830.

The statistics managing unit 810 generates statistical information on a quality level, an alerting processing history, and violation quality.

The analyzing and reporting unit 820 changes the quality analysis result by analyzing the generated statistical information from various angles to meet the reporting format, and provides it through the operator interface (not shown).

The verifying unit 830 receives the violation information to perform the verification work on the violation quality for the subscriber and the operator, and informs the operator of the violation information so that the violation does not recur for the violation quality determined as a violation by the verification result.

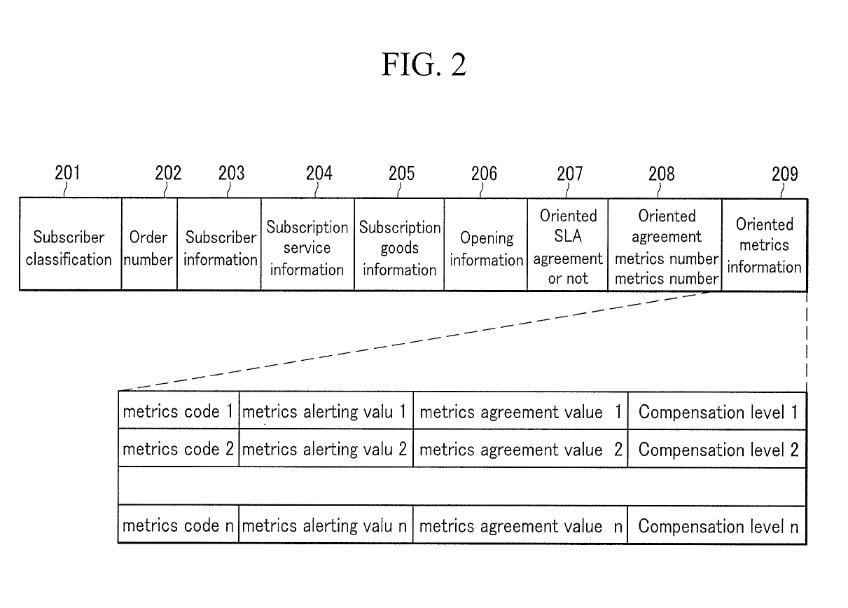

Next, in the system 10 for managing an SLA according to the exemplary embodiment of the present invention, the interface information for receiving the customer-oriented quality management metrics and metrics value information for each subscriber from the opening management system 20 will be described in detail with reference to FIG. 2.

FIG. 2 is a diagram showing interface information to allow a system for managing an SLA according to an exemplary embodiment of the present invention to receive information from an opening management system.

First, in order to manage the customer-oriented SLA quality, the SLA agreement metrics that is a metrics stipulated with each subscriber, the metrics value information, and the compensation level information should be collected and managed.

Therefore, the customer metrics policy managing unit 410 in the system 10 for managing an SLA according to an exemplary embodiment of the present invention collects the customer-oriented SLA agreement metrics, the metrics value information, and the compensation level information for each metrics from the opening management system 20.

In the present invention, the customer establishes a method for collecting the information on the agreement goods at the subscription time for profile, the SLA agreement metrics, the metrics value, and the compensation level information by the interface scheme. Hereinafter, the interface information according to the interface scheme will be described.

Referring to FIG. 2, the interface information includes information corresponding to subscriber classification 201, an order number 202, subscriber information 203, a subscription service 204, subscription goods 205, an opening desired date 206, a oriented SLA agreement 207, an oriented agreement metrics number 208, and an oriented metrics 209.

The information corresponding to the subscriber classification 201 needs to classify the subscribers and manage the quality for each subscriber. Further, the information corresponding to the subscriber classification 201 should be set to a unique value for each service.

The information corresponding to the order number 202 needs to classify and manage the continuity and separation characteristics for the received order information for each subscriber.

The information corresponding to the subscriber information 203 includes all the additional detailed information such as a subscriber name, address information, profile equipment type information, etc.

The information corresponding to the subscription service 204 includes the subscriber agreement service information.

The information corresponding to the subscription goods 205 includes the detailed goods information on services.

The information corresponding to the opening desired date 206 is information for determining the quality violation or not in the profile quality management.

The information corresponding to the oriented SLA agreement 207 or not may be input in a Yes/No form.

When the oriented SLA agreement information is input in a “No” form, it is determined that the information corresponding to the oriented agreement metrics number 208 is not the oriented SLA agreement subscriber, and the quality management is performed based on the quality metrics value defined in the same agreement for each service.

The information corresponding to the oriented metrics 209 internally includes the service level agreement code, the oriented metrics alerting value, the oriented metrics agreement value, and the compensation level information according to the oriented agreement level.

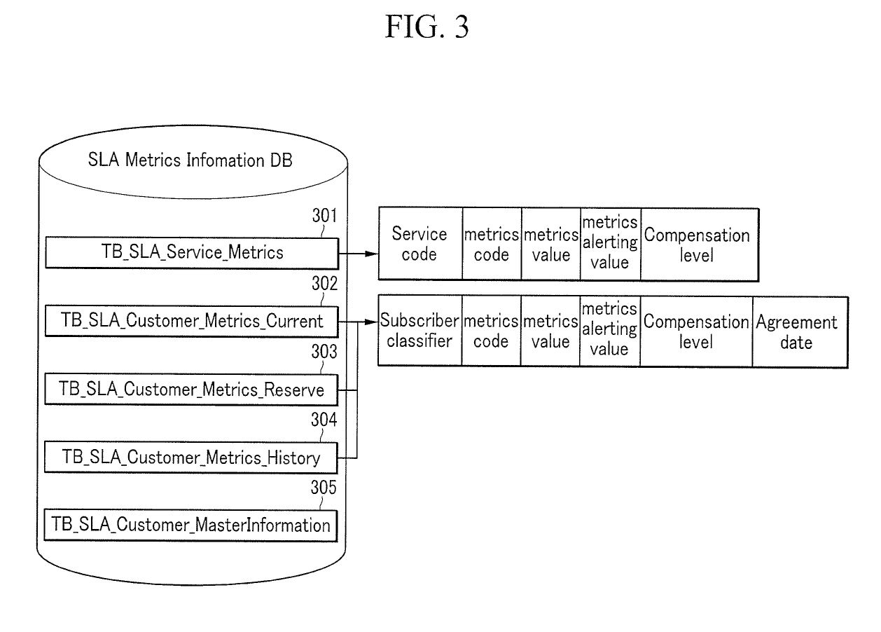

Next, the customer metrics policy managing unit 410 according to an exemplary embodiment of the present invention stores and manages the customer-oriented metrics information managing table in the SLA information unit 500. The customer-oriented metrics information managing table will be described with reference to FIG. 3.

FIG. 3 is a diagram showing a customer-oriented metrics information management table according to an exemplary embodiment of the present invention.

Referring to FIG. 3, the custom-oriented metrics information management table includes a first table (TB_SLA_Service_Metrics) 301, a second table (TB SLA_Customer_Metrics_Current) 302, a third table (TB_SLA_Customer_Metrics_Reserve) 303, a fourth table (TB_SLA_Customer_Metrics_History) 304, and a fifth table (TB_SLA_Customer_MasterInfomation) 305.

The first table 301 is a table that equally applies the quality information defined in an agreement for each service to a customer that does not stipulate with the customer-oriented SLA, among the metrics management tables for the customer-oriented metrics information management. Further, the first table 301 defines the service code, the metrics code, the metrics value, the metrics alerting value, and the compensation level information for each service and for each metrics.

The second table 302, the third table 303, and the fourth table 304 are metrics information management tables for customers stipulated with the customer-oriented service level agreement. In addition, each table 302, 303, and 304 includes the subscriber classifier, the metrics code, the metrics value, the metrics alerting value, the compensation level, and the stipulated date information.

In detail, the second table 302 is used as the customer-oriented quality management metrics information for application at the time of monitoring the iprofile quality, network performance quality, and fault quality, and determining the violation.

The third table 303 stores and manages the service level agreement quality information for application the following month when the service level agreement quality information is changed to prevent malicious customers from abusing the customer-oriented quality management function while changing the customer-oriented service level agreement quality information after profile.

The fourth table 304 stores and manages the agreement information at the time of new profile as well as the changed history of the stipulated service level agreement quality information of the subscriber by the change.

The fifth table 305 includes all the detailed information on a subscriber which includes the customer-oriented agreement or not for the subscriber and the goods information of the subscriber and is collected at the time of new profile. The information included in the fifteh table 305 is used as information referred to in the quality monitoring activity and the violation activity management.

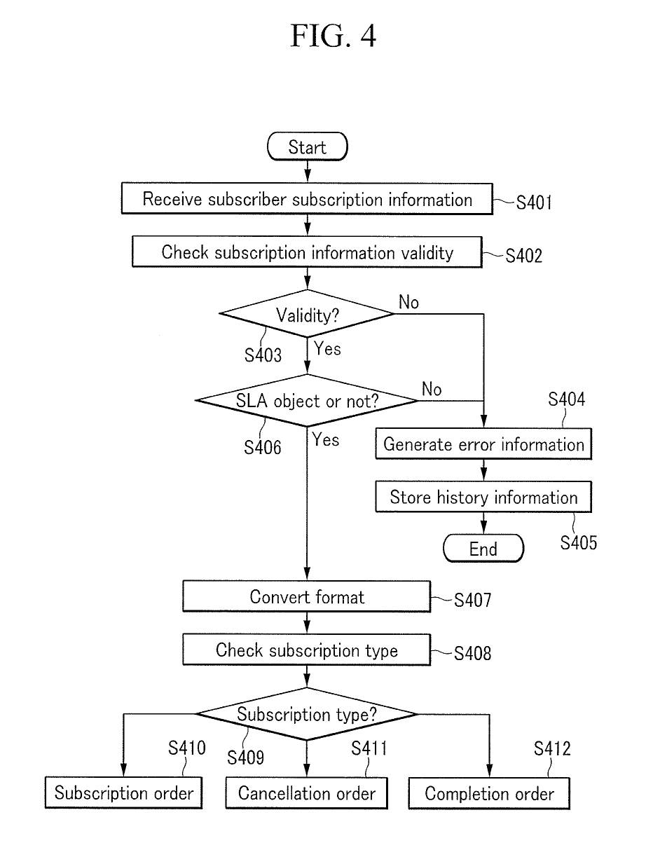

Next, in the customer metrics policy managing unit 410 and the profile quality monitoring unit 420 according to an exemplary embodiment of the present invention, the method for managing the customer-oriented service level agreement metrics and profile quality that performs the metrics management and the profile quality management will be described with reference to FIG. 4.

FIG. 4 is a flowchart showing the method for managing a customer-oriented service level agreement metrics and profile quality according to an exemplary embodiment of the present invention.

Referring to FIG. 4, the customer metrics policy managing unit 410 receives the profile quality information from the opening management system 20 through the OSS interworking device 100 (S401).

The profile quality monitoring unit 420 performs a validity check on the subscription information in the received profile quality information (S402) and determines whether there is validity (S403).

When the subscription information is invalid, the profile quality monitoring unit 420 generates error information (S404) and history information with the generated error information (S405).

When the subscription information is valid, the profile quality monitoring unit 420 determines the SLA object or not based on the service information or the service goods, or subscription type information (S406).

In the case of the SLA object, the profile quality monitoring unit 420 converts the received quality information into an internal data processing format (S407).

After converting the quality information format, the profile quality monitoring unit 420 checks the subscription type (S408) to determine the subscription type to correspond to the checking results. At this time, the subscription type is determined as one of the subscription order (S410), cancellation order (S411), and completion order (S412) types. In other words, the system for managing an SLA according to an exemplary embodiment of the present invention performs the custom-oriented SLA metrics management and the profile quality management to correspond to the determined subscription type.

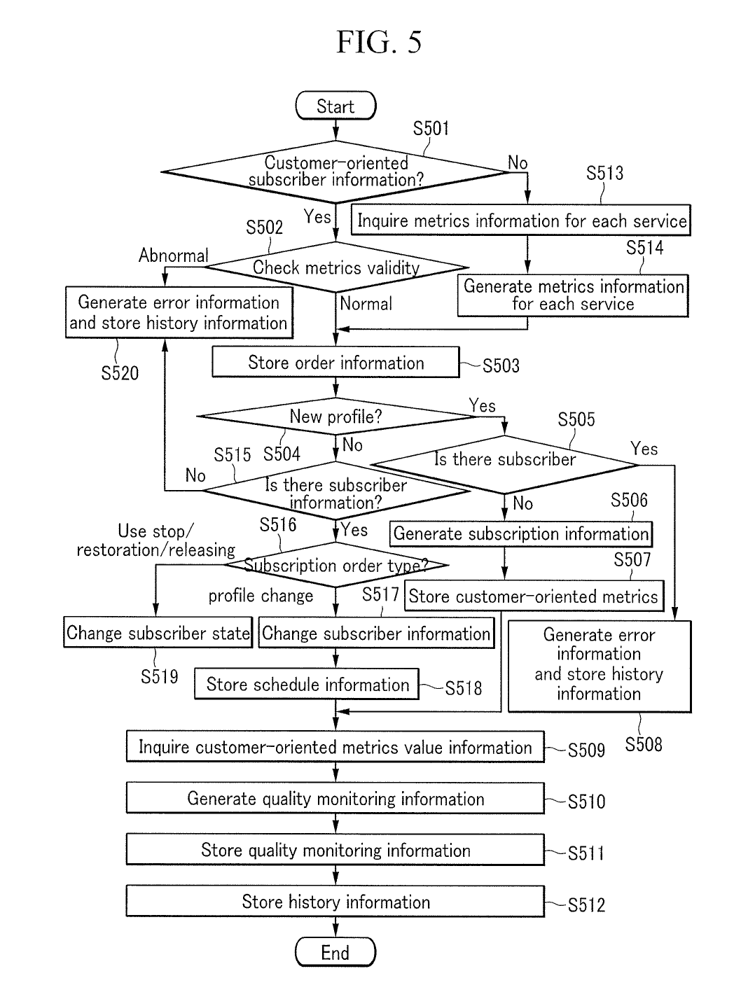

Next, the method for managing a customer-oriented network performance quality corresponding to the subscription type according to an exemplary embodiment of the present invention will be described with reference to FIGS. 5 to 7.

FIG. 5 is a flowchart showing a method for managing an SLA corresponding to a subscription order type of subscription types according to an exemplary embodiment of the present invention.

Referring to FIG. 5, the system for managing an SLA determines the information of the customer-oriented subscriber or not in the case of the subscription order type (S501). In the case of the customer-oriented subscriber information, the system for managing an SLA checks the validity of the customer-oriented metrics of the customer-oriented subscriber information (S502).

When the checking result is abnormal, the system for managing an SLA generates the error information and stores the history information with the generated error information. On the other hand, when the checking result is normal, the system for managing an SLA stores the generated order information in each case corresponding to the customer-oriented subscriber information (S503).

Next, the system for managing an SLA determines whether the subscription order type is new profile (S504). In the case of the new profile, it determines whether there is the subscriber information (S505).

When there is no subscriber information, the system for managing an SLA generates the subscriber information (S506). Further, the system for managing an SLA stores the customer-oriented metrics information in the second table (TB_SLA_Customer_Metrics_Current) 302 and the fourth table (TB_SLA_Customer_Metrics_History) 304 that are the customer-oriented metrics information management table of the customer metrics policy managing unit 410, respectively (S507). On the other hand, when there is subscriber information, the system for managing an SLA generates the error information and stores the history information with the generated error information (S508).

After step (S507), the system for managing an SLA uses the information stored in a table to inquire of the customer-oriented metrics value information (S509), and generates the quality monitoring information based on the inquired information (S510). Further, the system for managing an SLA stores the generated quality monitoring information in the corresponding monitoring information table (S511) and then stores the history information with the generated quality monitoring information therein (S512).

At step S504, when the subscription order type is not new profile, the system for managing an SLA determines whether there is subscriber information (S515). When there is no subscriber information, the system generates the error information and stores the history information with the generated error information. On the other hand, when there is subscriber information, the system for managing an SLA determines it as valid subscriber information and determines whether the subscription order type is profile change or use stop/restoration/cancellation (S516).

When the subscription order type is the profile change and the change order type after the profile, it changes the subscriber information (S517) and generates the customer-oriented metrics change schedule information and stores it in the third table (TB_SLA_Customer_Metrics_Reserve) 303 and the fourth table (TB_SLA_Customer_Metrics_History) 304 (S518). Next, the system for managing an SLA generates and stores the quality monitoring information similar to the operation of step S512 at step S509 after step S507.

At step S501, as a result of determining the information of the customer-oriented subscriber or not, when it is not the information of the customer-oriented subscriber, the system for managing an SLA inquires the metrics information for each service from the first table (TB_SLA_Service_Metrics) 301 (S513) and generates the subscriber metrics information using the information for each service (S514).

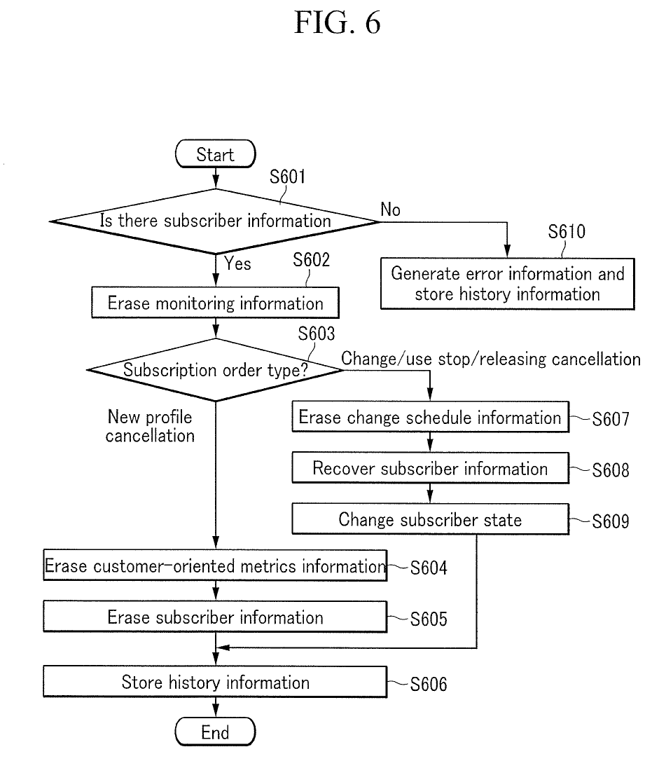

FIG. 6 is a flowchart showing a method for managing an SLA corresponding to a cancellation order type of subscription types according to an exemplary embodiment of the present invention.

Referring to FIG. 6, the system for managing an SLA determines whether there is subscriber information in the case of the cancellation order type (S601). When there is subscriber information, the system for managing an SLA erases the monitoring information to stop the monitoring activity for the previously collected profile quality information (S602).

The system for managing an SLA determines whether a cancellation order type is new profile cancellation and change/use stop/releasing cancellation (S603).

When a subscription order type is the new profile cancellation, the system for managing an SLA cancels the customer-oriented metrics information from the second table (TB_SLA_Customer_Metrics_Current) 302 (S604) and cancels the subscriber information (S605).

The system for an SLA stores the history information erasing the subscriber information (S606).

When the subscription order type is the change/use stop/releasing cancellation, the system for managing an SLA erases the customer-oriented metrics change schedule information in the third table (TB_SLA_Customer_Metrics_Reserve) 303 (S607) and recovers the subscriber information (S608). Next, the system for managing an SLA changes the subscriber state (S609) and stores the history information while changing the subscriber information.

At S601, as a result of determining whether there is subscriber information, when there is no subscriber information, the system for managing an SLA generates the error information and stores the history information with the generated error information (S610).

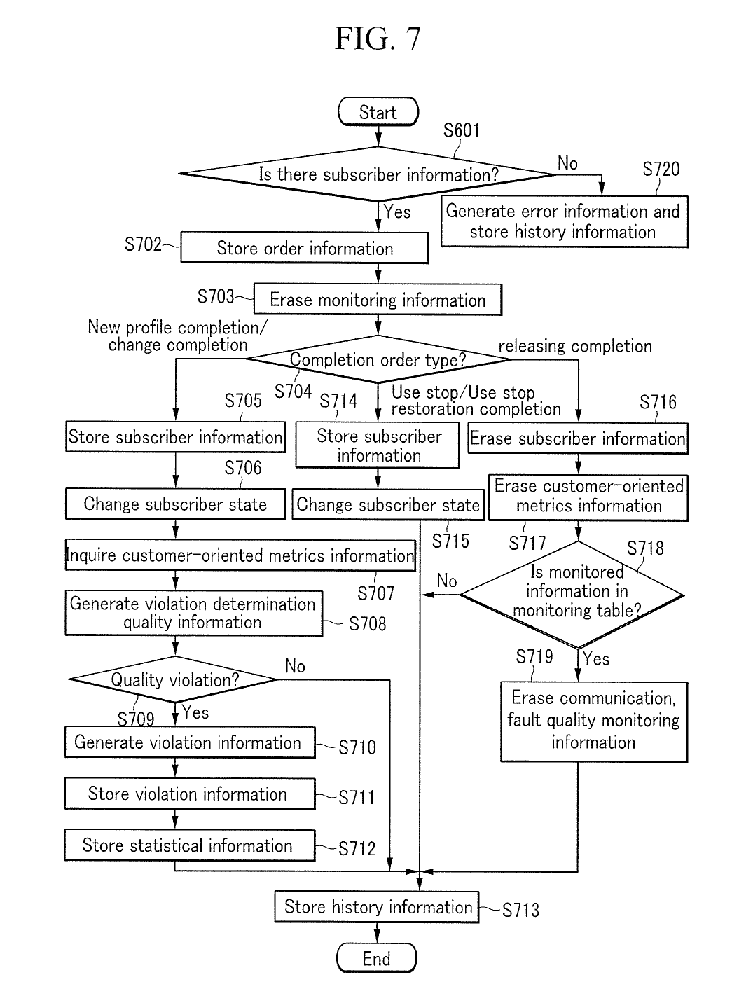

FIG. 7 is a flowchart showing a method for managing an SLA corresponding to a completion order type of subscription types according to an exemplary embodiment of the present invention.

Referring to FIG. 7, the system for managing an SLA determines whether there is subscriber information in the case of the completion order type (S701). When there is no subscriber information, the system for managing an SLA generates the error information and stores the history information with the generated error information.

On the other hand, when there is subscriber information, the system for managing an SLA stores the order information corresponding to the completion order type (S702). In addition, the system for managing an SLA erases the monitoring information to stop the monitoring activity for the profile quality information corresponding to the received subscriber (S703).

The system for managing an SLA determines whether the completion order type is the new profile completion/change completion or use stop/use stop restoration completion or releasing completion type (S704).

When the completion order type is the new profile completion/change completion, that is, the new profile or the completion for the change after the new profile, the system for managing an SLA stores the subscriber information and reflects the completed subscriber information (S705). Further, it changes the subscriber state to a normal service state (S706). After the state change, the system for managing an SLA inquires the custom-oriented metrics information from the second table (TB_SLA_Customer_Metrics_Current) 302 (S707) and generates the violation determination quality information corresponding to the profile quality (S708).

Next, the system for managing an SLA determines the quality violation or not based on the generated profile quality information (S709). When the violation occurs, the system for managing an SLA generates the violation information (S710) and stores the generated violation information (S711), and then generates and stores the statistical information of the generated violation information (S712). Moreover, the system for managing an SLA finally stores the history information corresponding to the new profile completion/change completion (S713).

When the completion order type is the use stop/use stop restoration completion, the system for managing an SLA stores the subscriber information (S714) and changes the subscriber state (S715). After the change, the system for managing an SLA finally stores the history information corresponding to the use stop/use stop restoration completion.

When the completion order type is the releasing order type, the system for managing an SLA erases the subscriber information from an original table, that is, the fifth table (TB_SLA_Customer_MasterInfomation) 305 (S716), and erases the customer-oriented metrics information from the second table (TB_SLA_Customer_Metrics_Current) 302 and the third table (TB_SLA_Customer_Metrics_Reserve) 303, that are the customer-oriented metrics information management tables (S717).

Next, the system for managing an SLA determines the fault and network performance quality information, which are being monitored, in the monitoring table (S718), and when there is a fault and network performance quality information, erases the communication and fault quality monitoring information (S719). After the erasing and change, the system for managing an SLA finally stores the history information corresponding to the releasing completion.

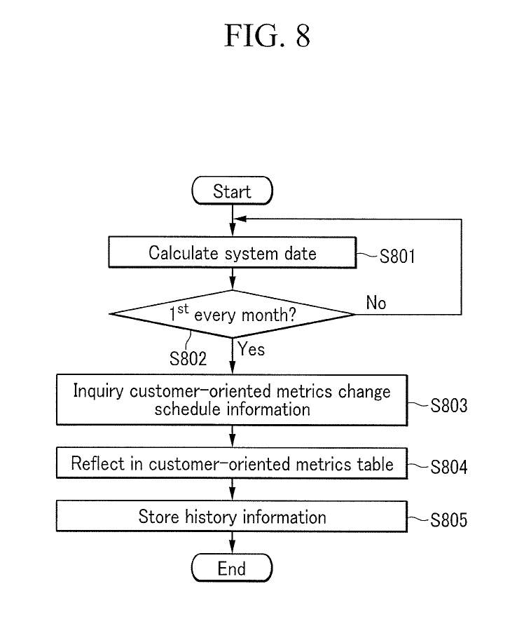

Next, in the customer-oriented metrics information management table according to an exemplary embodiment of the present invention, a method for processing a management function of the second table (TB_SLA_Customer_Metrics_Current) 302 and the third table (TB_SLA_Customer_Metrics_Reserve) 303 will be described with reference to FIG. 8.

FIG. 8 is a flowchart showing a method for processing a management function of a second table and a third table shown in FIG. 3

Referring to FIG. 8, the customer metrics policy managing unit 410 calculates a system date (S801) to confirm whether it is the first day every month (S802).

The customer metrics policy managing unit 410 uses a third table (TB _SLA_Customer_Metrics_Reserve) 303 and a fourth table (TB_SLA_Customer_Metrics_History) 304 to inquire of the corresponding information from the customer-oriented metrics change schedule table (S803). Further, the customer metrics policy managing unit 410 can inquire of the corresponding information from the customer-oriented metrics change schedule table and reflect it to the customer-oriented service level agreement quality metrics and metrics value change information collected through the change information.

The customer metrics policy managing unit 410 reflects the information of the third table (TB_SLA_Customer_Metrics_Reserve) 303 to the second table (TB_SLA_Customer_Metrics_Current) 302 that is the customer-oriented SLA metrics management table for each customer, based on the inquired information (S804). In addition, for the history of the second table reflecting the information of the third table, the history information is stored in the fourth table to (TB_SLA_Customer_Metrics_History) 304 (S805).

As described above, the method for managing a customer-oriented service level agreement metrics and the system for managing profile quality thereof according to the exemplary embodiment of the present invention can select different quality management metricses and metrics values for subscribers having subscribed to the same service and perform different quality management.

With the exemplary embodiment of the present invention, the system for managing a customer-oriented SLA receive the quality management metrics and metrics value information for each customer at the time of receiving information on new profile and the installaion change to manage the customer-oriented metrics and the SLA quality, thereby making it possible to provide the customer-oriented SLA quality management. In other words, the system for managing an SLA can efficiently manage the quality based on the quality metrics and quality metrics value selected by the customer, such that quality management with reliability and a premium quality management service can be provided to the subscribers.

In addition, the exemplary embodiment of the present invention applies for the profile quality management function of the customer quality (profile quality, network performance quality, and fault quality) management functions, making it possible to increase the satisfaction for the customer quality management and the reliability.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for managing a customer-oriented service level agreement that manages a customer-oriented service level agreement metrics and profile quality, comprising:
an interworking device that collects quality information including an SLA agreement metrics of a customer, metrics value, compensation level, profile quality information, fault quality information, network performance quality information and subscriber information for each customer;
a customer-oriented SLA metrics managing device that generates customer-oriented profile quality monitoring information corresponding to the customer based on the received SLA agreement metrics and metrics value for each customer and manages the quality;
an SLA quality managing device that monitors whether there is quality violation possibility for the generated customer-oriented profile quality monitoring information and determines the quality violation or not based on the SLA metrics and metrics value for each customer to perform the compensation processing corresponding to the quality violation according to the determination result; and
a providing device that provides statistical information on the quality level and the quality violation corresponding to the customer-oriented profile quality monitoring information and provides the statistical information to the customer.

2. The system for managing a customer-oriented service level agreement of claim 1, wherein
the customer-oriented SLA metrics managing device includes:
a customer metrics policy managing unit that collects and manages the SLA agreement metrics and metrics value and the compensation level information corresponding to each metrics for each customer;
a quality monitoring unit that generates a customer-oriented quality monitoring information corresponding to the customer-oriented quality management and quality;
a violation quality managing unit that manages the violation quality of the generated customer-oriented profile quality monitoring information; and
a fault quality managing unit that manages fault quality for each fault

3. The system for managing a customer-oriented service level agreement of claim 2, wherein
the customer metrics policy managing unit uses a customer-oriented metrics information management table to manage each customer, wherein the customer-oriented metrics information management table includes:
a first table that applies quality information for each service defined in an agreement to customers that do not conclude the customer-oriented SLA agreement, without discrimination;
a second table that manages the metrics information for the customer-oriented SLA agreement customer; and
a third table that includes the customer-oriented SLA agreement or not for the subscriber and the subscriber information collected at the time of profile including goods information of the subscriber.

4. The system for managing a customer-oriented service level agreement of claim 2, wherein
the SLA quality managing device includes:
an SLA monitoring unit that periodically monitors quality violation possibility of the customer-oriented profile quality monitoring information;
an SLA alerting unit that generates alerting information when there is a violation possibility according to the results monitored in the SLA monitoring unit;
an SLA violation information unit that generates the violation information when a violation in quality managed in the profile quality monitoring unit, the violation quality managing unit, and the fault quality managing unit occurs; and
a repayment calculating unit that calculates repayment based on the SLA agreement metrics and metrics value and the compensation level for each metrics.

5. The system for managing a customer-oriented service level agreement of claim 1, wherein
the providing device includes:
a statistics managing unit that generates statistical information on a quality level, an alerting processing history, and violation quality;
an analyzing and reporting unit that changes the quality analysis result and analyzes the generated statistical information from various angles to meet the reporting format; and
a verifying unit that verifies quality based on the violation information corresponding to the quality violation and informs it to the outside so that the violation does not recur for the violation quality determined as violation by the verification result.

6. A method for managing a customer-oriented service level agreement metrics and profile quality, comprising:
collecting quality information, which includes an SLA agreement metrics of a customer, metrics value, compensation level, profile quality information, fault quality information, network performance quality information and subscriber information for each customer;
managing quality by generating customer-oriented profile quality monitoring information corresponding to the customer based on the received SLA agreement metrics and metrics value for each customer;
monitoring quality violation possibility or not for the generated customer-oriented profile quality monitoring information; and
generating statistical information on quality violation and a quality level corresponding to customer-oriented profile quality monitoring information and providing the statistical information to the customer.

7. The method for managing a customer-oriented service level agreement metrics and profile quality of claim 6, wherein
the managing the quality by generating the customer-oriented profile quality monitoring information includes
checking a subscription type of the generated customer-oriented profile quality monitoring information to determine the subscription type as one of a subscription order, a cancellation order, and a completion order to correspond to the checking results.

8. The method for managing a customer-oriented service level agreement metrics and profile quality of claim 7, wherein
a method for processing the subscription order type in the determining the subscription type includes:
checking validity of the subscriber information with respect to the customer-oriented metrics when the quality information is the customer-oriented subscriber information;
when the validity checking result is normal, storing order information for each case corresponding to the subscriber information;
changing or generating the subscriber information to correspond to the determination result by determining whether the subscription order type is new profile; and
inquiring of the customer-oriented metrics value information based on the changed or generated subscriber information to generate the customer-oriented quality monitoring information based on the inquired information.

9. The method for managing a customer-oriented service level agreement metrics and profile quality of claim 7, wherein
a method for processing a cancellation order type in the determining the subscription type includes:
when there is no subscriber information in the quality information, generating error information and storing history information with the generated error information;
when there is subscriber information in the quality information, erasing the profile quality monitoring information to stop the monitoring activity for the previously collected quality information;
when the cancellation order type is new profile cancellation, erasing the metrics and the subscriber information; and
when the cancellation order type is change/use stop/releasing cancellation, erasing customer-oriented metrics change schedule information and recovering the subscriber information to change the subscriber state.

10. The method for managing a customer-oriented service level agreement metrics and profile quality of claim 7, wherein
a method for processing the completion order type in the determining the subscription type includes:
when there is no subscriber information in the quality information, generating the error information and storing history information with the generated error information;
when there is subscriber information in the quality information, storing the order information corresponding to the completion order type; and
erasing the profile quality monitoring information corresponding to the quality information corresponding to the subscriber to perform the metrics and the profile quality management according to the completion order type.
